(19) United States
(12) Patent Application Publication
(10) Pub. No.: US 2013/0304852 A1
(43) Pub. Date: Nov. 14, 2013

(54) DISTRIBUTION APPARATUS, DISTRIBUTION SYSTEM AND METHOD

(71) Applicant: Tetsuhiko OMORI, Chiba (JP)

(72) Inventor: Tetsuhiko OMORI, Chiba (JP)

(73) Assignee: RICOH COMPANY, LTD., Tokyo (JP)

(21) Appl. No.: 13/875,391

(22) Filed: May 2, 2013

(30) Foreign Application Priority Data
May 14, 2012 (JP) 2012-110297

(51) Int. Cl. H04L 29/08

(52) U.S. Cl. CPC H04L 67/02
USPC 709/217

(57) ABSTRACT

A distribution apparatus may include a judging unit that judges whether to distribute data, based on position information received from an apparatus and position condition information that is preset, and a data distributing unit that distributes the data to a distributing destination when the judging unit judges to distribute the data.

### CROSS-REFERENCE TO RELATED APPLICATIONS

This application is based upon and claims the benefit of priority of the Japanese Patent Application No. 2012-110297, filed on May 14, 2012, the entire contents of which are incorporated herein by reference.

### BACKGROUND OF THE INVENTION

1. Field of the Invention

The present invention generally relates to a communication system.

2. Description of the Related Art

When transmitting data to an individual, information (or a distributing destination) of a receiver may be set in order to transmit the data.

In data distribution, a schedule of distribution processes may be registered together with the data to be distributed, in order to perform a distribution process at a specified time. Such a distribution is proposed in a Japanese Laid-Open Patent Publication No. 2000-122953, for example.

When transmitting the data to the receiver, the data is transmitted immediately to the receiver. For this reason, when a terminal that received the data is lost by the time when the data is required, information leak may occur.

On the other hand, in the system in which the schedule of the distribution processes are registered together with the data to be distributed, when the time when the data is required is delayed for some reason, the data may be received by the terminal before the data is required. In this case, when the terminal that received the data is lost, information leak may occur. Further, when the time when the data is required is advanced for some reason, the required data may not be acquired.

### SUMMARY OF THE INVENTION

Accordingly, it is a general object in one embodiment of the present invention to provide a novel and useful distribution apparatus, distribution system and method, in which at least one of the problems described above may be suppressed.

According to one aspect of the present invention, a distribution apparatus may include a judging unit configured to judge whether to distribute data, based on position information received from an apparatus and position condition information that is preset; and a data distributing unit configured to distribute the data to a distributing destination when the judging unit judges to distribute the data.

According to another aspect of the present invention, a distribution method may include judging, in a judging unit, whether to distribute data, based on position information received from an apparatus and position condition information that is preset; and distributing, from a data distributing unit, the data to a distributing destination when the judging judges to distribute the data.

According to still another aspect of the present invention, a distribution system may include a plurality of apparatuses configured to communicate with each other, wherein a first apparatus amongst the plurality of apparatuses performs a process including judging whether to distribute data, based on position information received from a second apparatus amongst the plurality of apparatuses and position condition information that is preset; and distributing the data to a distributing destination when the judging judges to distribute the data.

According to another aspect of the present invention, a carrier medium may save a program representing a sequence of instructions, the program which when executed by a computer included in a collaboration processing apparatus that is connected to a plurality of electronic apparatuses, may receive a request from an application installed in the collaboration processing apparatus, and control the electronic devices based on the received request to perform a collaboration process by causing the application and the electronic devices to collaborate, the instructions cause the computer to function as a judging unit configured to judge whether to distribute data, based on position information received from an apparatus and position condition information that is preset; and a data distributing unit configured to distribute the data to a distributing destination when the judging unit judges to distribute the data.

Other objects and further features of the present invention will be apparent from the following detailed description when read in conjunction with the accompanying drawings.

### BRIEF DESCRIPTION OF THE DRAWINGS

FIG. 1 is a diagram illustrating an information distribution system in one embodiment;

FIG. 2 is a diagram illustrating an image forming apparatus in one embodiment;

FIG. 3 is a functional block diagram illustrating the image forming apparatus in one embodiment;

FIG. 4 is a diagram illustrating a display screen for selecting a workflow in one embodiment;

FIG. 5 is a diagram illustrating the workflow in one embodiment;

FIG. 6 is a diagram illustrating a display screen for specifying a distributing destination in one embodiment;

FIG. 7 is a diagram illustrating a distributing destination table in one embodiment;

FIG. 8 is a diagram illustrating a position information confirmation terminal table in one embodiment;

FIG. 9 is a diagram illustrating a position information table in one embodiment;

FIG. 10 is a diagram illustrating a distribution apparatus in one embodiment;

FIG. 11 is a functional block diagram illustrating the distribution apparatus in one embodiment;

FIG. 12 is a diagram illustrating a data structure of jobs in one embodiment;

FIG. 13 is a diagram illustrating a job registration table in one embodiment;

FIG. 14 is a diagram illustrating a portable terminal in one embodiment;

FIG. 15 is a functional block diagram illustrating the portable terminal in one embodiment;

FIG. 16 is a diagram illustrating an operation of the information distribution system in one embodiment;

FIG. 17 is a diagram illustrating a retry interval setting table in one embodiment;

FIG. 18 is a diagram illustrating an operation of the information distribution system in one embodiment;

FIG. 19 is a diagram illustrating the retry interval setting table in one embodiment;

FIG. 20 is a diagram illustrating an operation of the information distribution system in one embodiment;

FIG. 21 is a functional block diagram illustrating the portable terminal in one embodiment;

FIG. 22 is a diagram illustrating an operation of the information distribution system in one embodiment;

FIG. 23 is a diagram illustrating a first example of an application of the information distribution system;

FIG. 24 is a diagram illustrating a second example of the application of the information distribution system;

FIG. 25 is a diagram illustrating a third example of the application of the information distribution system;

FIG. 26 is a diagram illustrating a fourth example of the application of the information distribution system;

FIG. 27 is a diagram illustrating a fifth example of the application of the information distribution system; and

FIG. 28 is a diagram illustrating a sixth example of the application of the information distribution system.

### DESCRIPTION OF THE PREFERRED EMBODIMENTS

A description will be given of embodiments of the distribution apparatus, distribution system and method according to the present invention, by referring to the drawings.

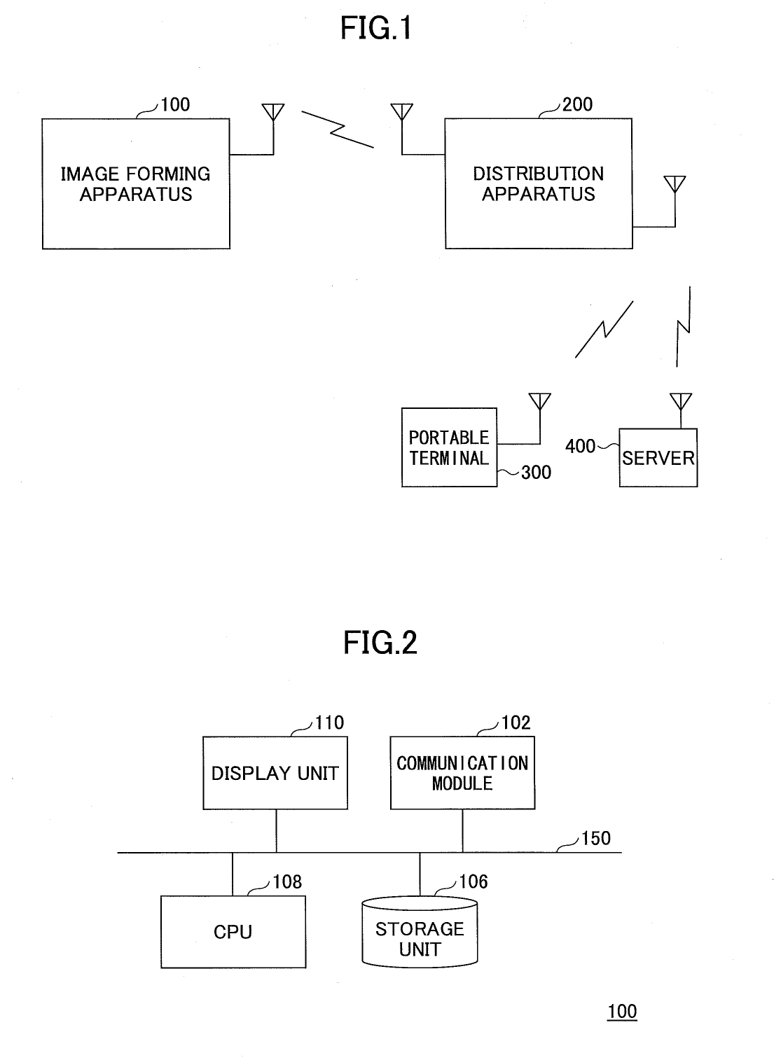

In FIGS. 1 through 28, those parts that have the same functions are designated by the same reference numerals, and a description thereof will be omitted.

### Embodiments

<Information Distribution System>

FIG. 1 is a diagram illustrating an information distribution system in one embodiment.

The information distribution system in one embodiment may include an image forming apparatus 100, a distribution apparatus 200, a portable terminal 300, and a server 400. A mobile communication apparatus, a projector, a communication apparatus, and the like may be used in place of the image forming apparatus 100. In addition, a mobile communication apparatus, a projector, a communication apparatus, and the like may be used in place of each of the portable terminal 300 and the server 400.

In the information distribution system, data from the image forming apparatus 100 may be transmitted by the distribution apparatus 200 to the portable terminal 300 and the server 400. For example, data scanned by a scanner of the image forming apparatus 100 may be transmitted to the portable terminal 300 and the server 400.

The information distribution system in one embodiment will be described for a case in which the image forming apparatus 100 and the distribution apparatus 200 are separate apparatuses, however, the image forming apparatus 100 and the distribution apparatus 200 may be integrated into one apparatus. Further, the number of distribution apparatuses 200 within the information distribution system is not limited to one, and a plurality of distribution apparatuses 200 may be provided within the information distribution system.

When specifying the data to be transmitted in the information distribution system, the position of the portable terminal 300 may be specified together with the distributing destination of the data. For example, a location (distributing position) where the data is utilized may be specified as the position of the portable terminal 300. By specifying the location where the data is utilized, the distribution of the data may be delayed until a receiver of the data reaches the location where the data is required or is utilized. For this reason, when it is assumed that the location where the data is utilized cannot be specified, the information leak may be prevented when the portable terminal 300 storing the data is lost, for example.

<Image Forming Apparatus 100>

FIG. 2 is a diagram illustrating the image forming apparatus 100 in one embodiment.

The image forming apparatus 100 may include a communication module 102, a storage unit 106, a CPU (Central Processing Unit) 108, and a display unit 110. The communication module 102, the storage unit 106, the CPU 108, and the display unit 110 may be connected via a bus 150.

The CPU 108 may control various parts of the image forming apparatus 100. For example, the CPU 108 may control various parts of the image forming apparatus 100 according to a command input by a user viewing the display unit 110, for example. The display 110 may be formed by a touchscreen panel or the like which enables the user to input the command. For example, the CPU 108 may carry out a control to transmit image data that is generated when a scanner (not illustrated) of the image forming apparatus 100 reads a paper document.

The communication module 102 may communicate with the distribution apparatus 200. The communication module 102 and the distribution apparatus 200 may be connected by a cable LAN (Local Area Network), such as the ETHERNET (registered trademark), or by a wireless LAN.

The storage unit 106 may store one or more application programs and an OS (Operating System). The application program is the software having functions enabling the user to execute operations on the image forming apparatus 100. The OS is the software providing hardware abstraction interfaces with respect to the application programs in the image forming apparatus 100. In addition, the storage unit 106 may store information of the distribution apparatus 200 coordinated or linked with the image forming apparatus 100.

The display unit 110 may include an operation panel of the image forming apparatus 100. The display unit 110 may display conditions for specifying the data to be distributed from the image forming apparatus 100 to the portable terminal 300 and the server 400.

<Functions of Image Forming Apparatus 100>

A description will be given of the functions of the image forming apparatus 100 in one embodiment.

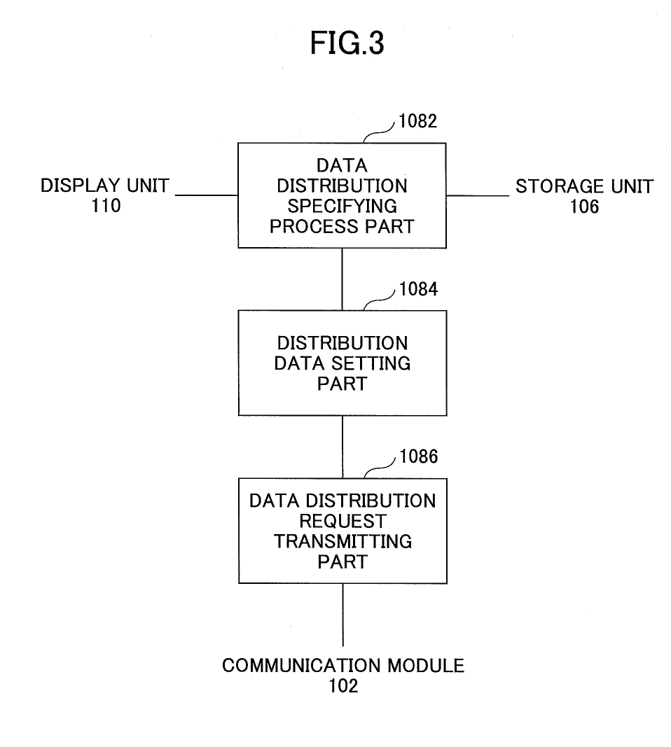

FIG. 3 is a functional block diagram illustrating the functions of the image forming apparatus 100 in one embodiment. The functions illustrated in FIG. 3 may mainly be executed by the CPU 108. In other words, the functions illustrated by the functional block diagram of FIG. 3 may be executed by the CPU 108 according to the application programs stored in the storage unit 106.

The CPU 108 may function as a data distribution specifying process part 1082. Workflows and distributing destination specifying information are input to the data distribution specifying process part 1082 from the display unit 110.

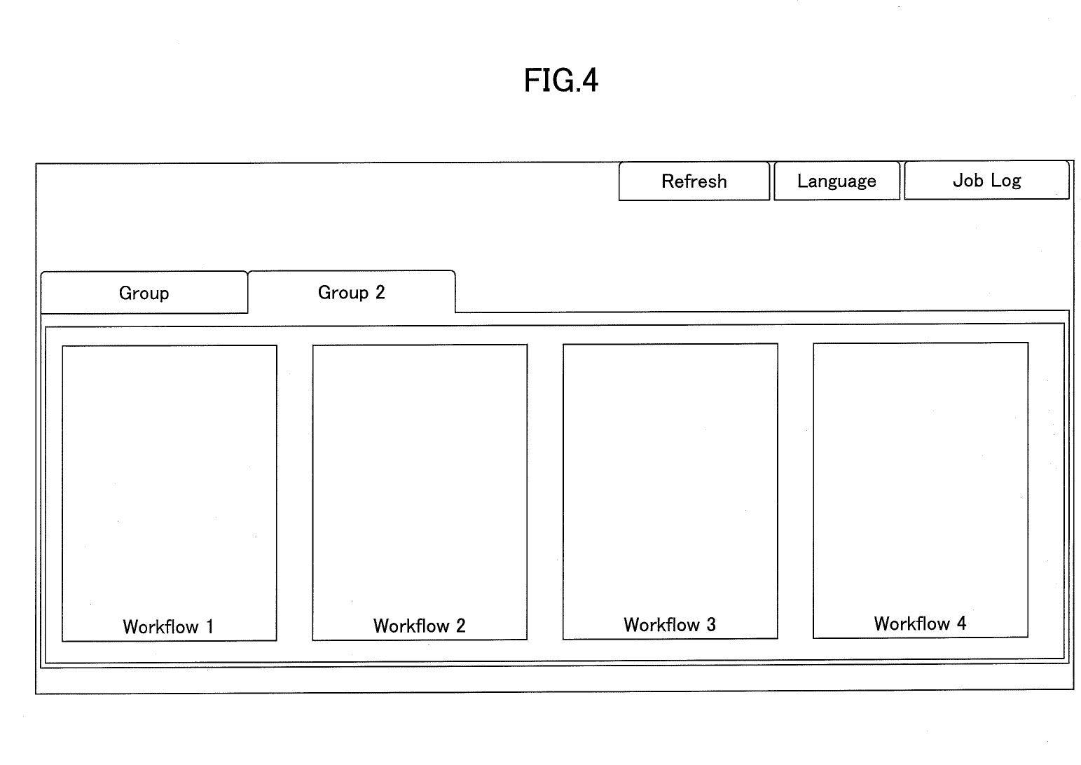

FIG. 4 is a diagram illustrating a display screen for selecting a workflow in one embodiment, displayed on the display unit 110 when specifying the data distribution.

Flows of a plurality of processes (hereinafter also referred to as “workflows”) are set to the image forming apparatus 100. In the example illustrated in FIG. 4, the display screen enables selection of a desired workflow from four kinds of workflows that are set in advance. FIG. 4 merely illustrates an example, and the selectable workflows may be set arbitrarily. When specifying the desired workflow, the user may touch the desired workflow displayed on the display screen of the display unit 110. Information corresponding to the desired workflow may be input from the display unit 110 to the data distribution specifying process part 1082, in response to the touching of the desired workflow on the display screen. By specifying the workflow, the user may set a plurality of processing procedures in one operation, without having to successively set the processing procedures. Of course, a plurality of processes may be set successively when desired, instead of selecting the workflow.

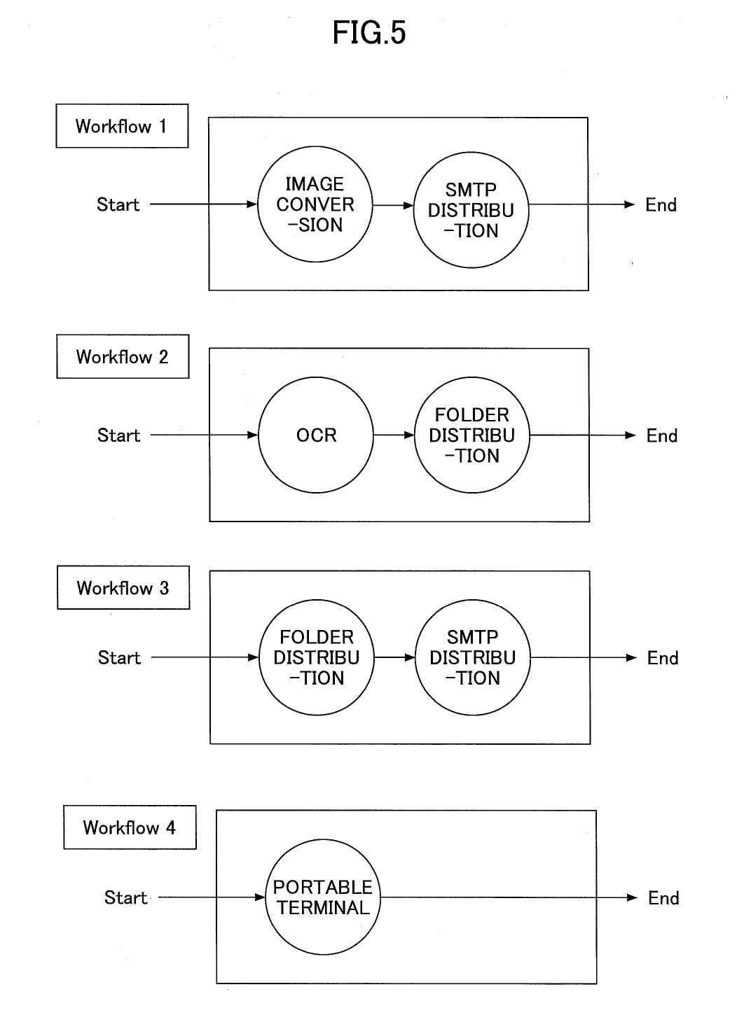

FIG. 5 is a diagram illustrating the workflow in one embodiment.

When a workflow 1 is selected, the data to be distributed may be set to be subjected to an image conversion and transferred using a protocol for transferring an electronic mail, such as the SMTP (Simple Mail Transfer Protocol) or the like. In other words, in the case of the workflow 1, the image data to be distributed may be set so that the image format of the data is converted and the converted data is added to the mail and transmitted.

When a workflow 2 is selected, the data to be distributed may be set to be read by a character reader using OCR (Optical Character Recognition) or the like, and distributed to a folder.

When a workflow 3 is selected, the data to be distributed may be set to be sent to a folder and distributed using the SMTP.

When a workflow 4 is selected, the data to be distributed may be set to be transmitted to the portable terminal 300.

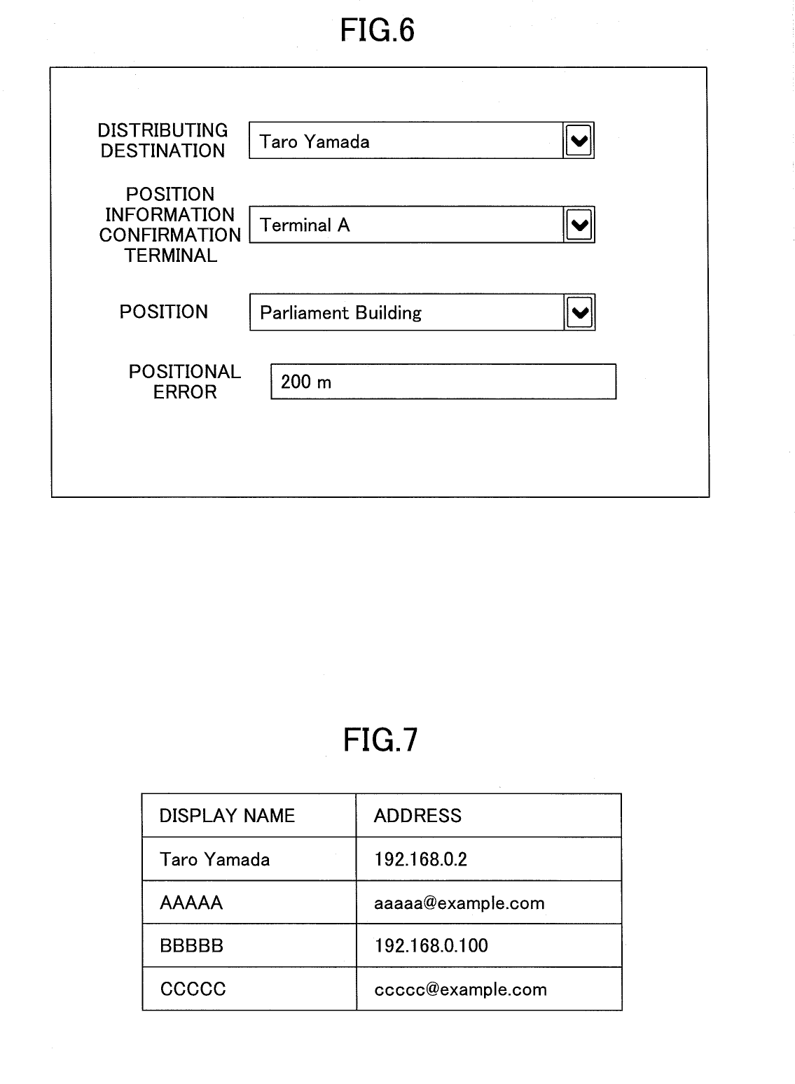

FIG. 6 is a diagram illustrating a display screen for specifying a distributing destination in one embodiment, displayed on the display unit 110 when specifying the distributing destination.

In the example illustrated in FIG. 6, when specifying the distributing destination, the display unit 110 may display a pull-down menu for specifying the distributing destination, the position information confirmation terminal, the position, and the positional error. The user may specify the distributing destination, the position information confirmation terminal, the position, and the positional error by selecting desired items from items that are displayed on the pull-down menu. Information indicating the specified distributing destination, position information confirmation terminal, position, and positional error may be transmitted from the display unit 110 to the data distribution specifying process part 1082.

In the example illustrated in FIG. 6, the distributing destination “Taro Yamada”, the position information confirmation terminal “terminal A”, the position “parliament building”, and the positional error “200 m” are selected.

The data distribution specifying process part 1082 may acquire an address corresponding to the specified distributing destination. More particularly, the storage unit 106 may store a distributing destination table indicating a correspondence of the distributing destinations and the addresses of the distributing destinations. The data distribution specifying process part 1082 may refer to the distributing destination table, and acquire the address corresponding to the specified distributing destination. By preparing the distributing destination table in advance, the user may specify the distributing destination by simply specifying the address corresponding to the distributing destination.

FIG. 7 is a diagram illustrating the distributing destination table in one embodiment.

The distributing destination table illustrated in FIG. 7 may indicate the correspondence of a display name (or identification name) of the distributing destination and the address of the distributing destination. In the example illustrated in FIG. 7, the address “192.168.0.2” corresponds to the display name “Taro Yamada” of the distributing destination. In addition, the address “aaaaa@example.com” corresponds to the display name “AAAAA” of the distributing destination.

The address “192.168.0.100” corresponds to the display name “BBBBB” of the distributing destination. Moreover, the address “ccccc@example.com” corresponds to the display name “CCCCC” of the distributing destination. Although the display names of the plurality of distributing destinations and the addresses correspond one-to-one (1:1) in the example illustrated in FIG. 7, a plurality of addresses may correspond to the display name of one distributing destination. In other words, the display names of the distributing destinations and the addresses may have a one-to-many (1:n, where n is a natural number greater than or equal to 2) correspondence. In the case in which the display names of the distributing destinations and the addresses have the one-to-many correspondence, the address may be selected according to the workflow, or a screen for selecting the address may be prepared. The user may select the address to be used from the screen for selecting the address. On the other hand, when selecting the address according to the workflow, the mail address may be selected automatically in a case in which the distribution is made according to the SMTP, as in the case of the workflows 1 and 2, for example.

The data distribution specifying process part 1082 may acquire an ID (hereinafter also referred to as a “terminal ID”) of the specified position information confirmation terminal. More particularly, the storage unit 106 may store a position information confirmation terminal table indicating a correspondence of the position information confirmation terminal and the terminal ID of the position information confirmation terminal. The data distribution specifying process part 1082 may refer to the position information confirmation terminal table, and acquire the terminal ID corresponding to the specified position information confirmation terminal. By preparing the position information confirmation terminal table in advance, the data distribution specifying process part 1082 may specify the position information confirmation terminal.

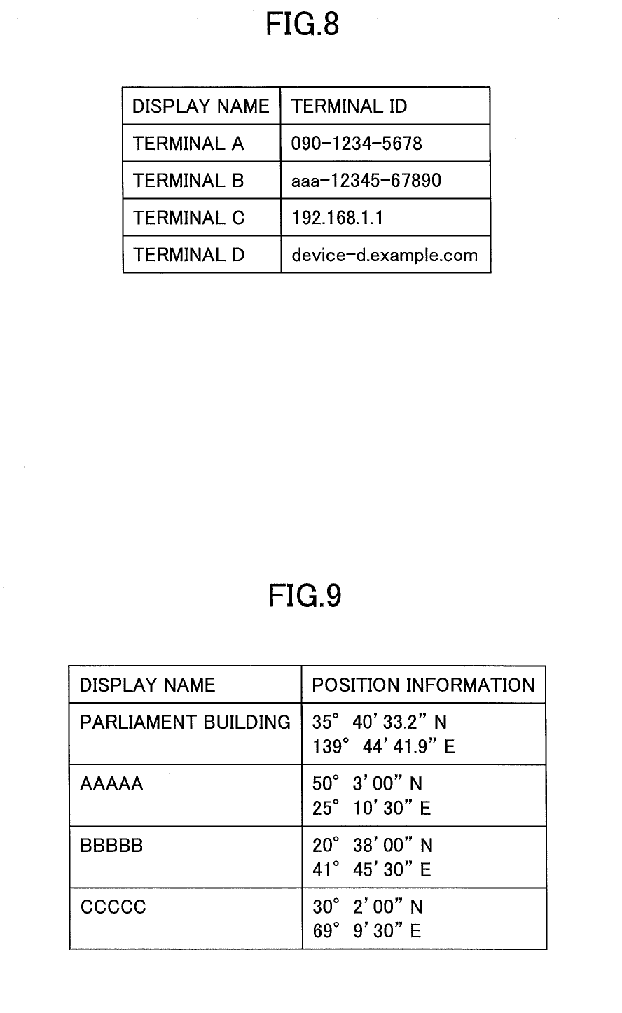

FIG. 8 is a diagram illustrating the position information confirmation terminal table in one embodiment.

The position information confirmation terminal table illustrated in FIG. 8 may indicate the correspondence of the display name of the position information confirmation terminal and the terminal ID of the position information confirmation terminal. In the example illustrated in FIG. 8, the telephone number “090-1234-5678” corresponds, as the terminal ID, to the display name “terminal A” of the position information confirmation terminal. In addition, the telephone number “aaa-12345-67890” corresponds, as the terminal ID, to the display name “terminal B” of the position information confirmation terminal. The IP (Internet Protocol) address “192.168.1.1” corresponds, as the terminal ID, to the display name “terminal C” of the position information confirmation terminal. Moreover, the mail address “device-d.example.com” corresponds, as the terminal ID, to the display name “terminal D” of the position information confirmation terminal. Although the display names of the plurality of distributing destinations and the terminal IDs correspond one-to-one (1:1) in the example illustrated in FIG. 8, a plurality of terminal IDs may correspond to the display name of one distributing destination. In other words, the display names of the distributing destinations and the terminal IDs may have a one-to-many (1:n, where n is a natural number greater than or equal to 2) correspondence. In the case in which the display names of the distributing destinations and the terminal IDs have the one-to-many correspondence, the terminal ID may be selected according to the workflow, or a screen for selecting the terminal ID may be prepared. The user may select the terminal ID to be used from the screen for selecting the terminal ID. By preparing the position information confirmation terminal table in advance, the user may simply select the display name in order to automatically select the terminal ID corresponding to the display name.

The data distribution specifying process part 1082 may acquire the position information corresponding to the specified position or location. More particularly, the storage unit 106 may store a position information table indicating a correspondence of the position or location and the position information corresponding to the position or location. The data distribution specifying process part 1082 may refer to the position information table, and acquire the position information corresponding to the specified position or location. By preparing the position information table in advance, the user may simply specify the position or location in order to automatically select the position information corresponding to the position or location. For this reason, the user does not need to input the position information every time a transmission is made.

FIG. 9 is a diagram illustrating the position information table in one embodiment.

The position information table illustrated in FIG. 9 may indicate the correspondence of the display name of the position or location and the position information of the position or location. In the example illustrated in FIG. 9, the position information “35°40′33.2″N (north latitude) 139°44′41.9″E (east longitude)” corresponds to the display name “parliament building” of the position or location. In addition, the position information “50°3′00″N (north latitude) 25°10′30″E (east longitude)” corresponds to the display name “AAAAA” of the position or location. The position information “20°38′00″N (north latitude) 41°45′30″E (east longitude)” corresponds to the display name “BBBBB” of the position or location. Moreover, the position information “30°2′00″N (north latitude) 69°9′30″E (east longitude)” corresponds to the display name “CCCCC” of the position or location. The example illustrated in FIG. 9 uses the north latitude and the east longitude as the position information, however, the position is not limited to such. Although the display names of the plurality of positions or locations and the position information correspond one-to-one (1:1) in the example illustrated in FIG. 9, a plurality of position information may correspond to the display name of one position or location. In other words, the display names of the positions or locations and the position information may have a one-to-many (1:n, where n is a natural number greater than or equal to 2) correspondence. In the case in which the display names of the positions or locations and the position information have the one-to-many correspondence, the position information may be selected according to the workflow, or a screen for selecting the position information may be prepared. The user may select the position information to be used from the screen for selecting the position information.

Further, the position information may include height information or floor information that indicates the number of floors of a building. By including the height information or the floor information of the building, the position information may be specified in more detail. For example, the height information and the floor information may be specified, for example, in order to specify the height or the number of floors of the specified building.

The data distribution specifying process part 1082 may input the address of the distributing destination, the terminal ID of the position information confirmation terminal, and the position information of the position or location, together with the distributing destination, the position information confirmation terminal, the position, and the positional error, to a distribution data setting part 1084.

The CPU 108 may function as the distribution data setting part 1084. The distribution data setting part 1084 may acquire the data to be distributed, according to the workflow specified by the user. For example, the distribution data setting part 1084 may convert the image format of the data to be distributed, and execute a control to read using the OCR.

The distribution data setting part 1084 may input the data to be distributed, together with the information from the data distribution specifying process part 1082, to a data distribution request transmitting part 1086.

The CPU 108 may function as the data distribution request transmitting part 1086. The data distribution request transmitting part 1086 may transmit a data distribution request including the information from the distribution data setting part 1084 and the data to be distributed, to the distribution apparatus 200. The data distribution request may be set from the communication module 102 to the distribution apparatus 200.

<Distribution Apparatus 200>

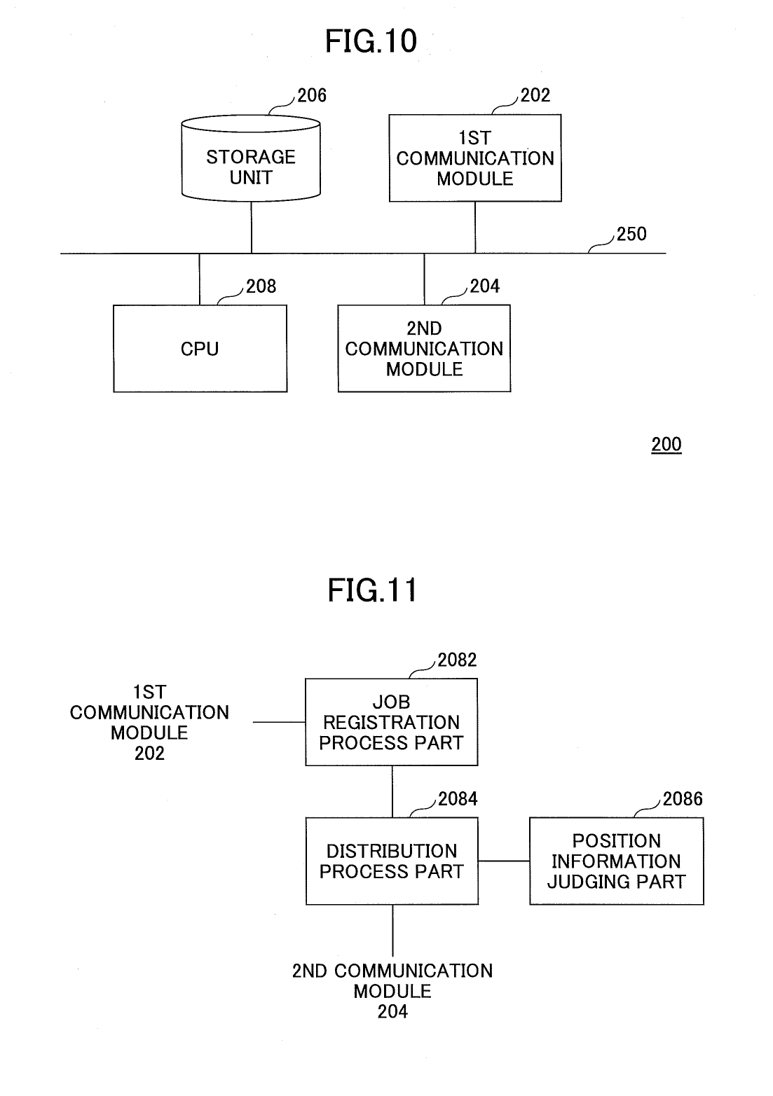

FIG. 10 is a diagram illustrating the distribution apparatus 200 in one embodiment.

The distribution apparatus 200 illustrated in FIG. 10 may include a first communication module 202, a second communication module 204, a storage unit 206, and a CPU 208. The first communication module 202, the second communication module 204, the storage unit 206, and the CPU 208 may be connected via a bus 250.

The CPU 208 may control various parts of the distribution apparatus 200.

The first communication module 202 may communicate with the image forming apparatus 100. The first communication module 202 and the image forming apparatus 100 may be connected by a cable LAN, such as the ETHERNET (registered trademark), or by a wireless LAN.

The second communication module 204 may communicate with the portable terminal 300 and the server 400. The second communication module 204, the portable terminal 300, and the server 400 may be connected by a mobile communication system, a wireless LAN, and the like.

The storage unit 206 may store application programs and an OS (Operating System). The application program is the software having functions enabling the user to execute operations on the distribution apparatus 200. The OS is the software providing hardware abstraction interfaces with respect to the application programs in the distribution apparatus 200.

<Functions of Distribution Apparatus 200>

A description will be given of the functions of the distribution apparatus 200 in one embodiment.

FIG. 11 is a functional block diagram illustrating the functions of the distribution apparatus 200 in one embodiment. The functions illustrated in FIG. 11 may mainly be executed by the CPU 208. In other words, the functions illustrated by the functional block diagram of FIG. 11 may be executed by the CPU 208 according to the application programs stored in the storage unit 206.

The CPU 208 may function as a job registration process part 2082. The data distribution request from the first communication module 202 may be input to the job registration process part 2082. The job registration process part 2082 may register the data distribution request in a job registration table that registers jobs.

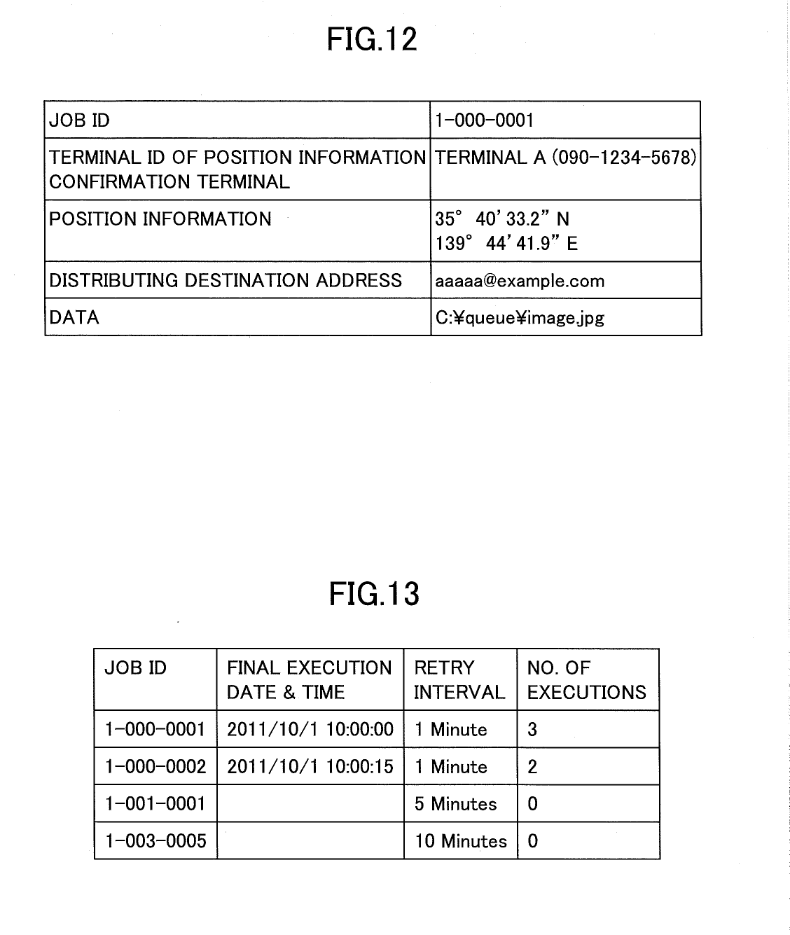

FIG. 12 is a diagram illustrating a data structure of the jobs in one embodiment.

The job may include a job ID, the terminal ID of the position information confirmation terminal, the position information of the position or location, the address of the distributing destination, and the data.

In the example illustrated in FIG. 12, the terminal ID “090-1234-5678” of the terminal A is set as the terminal ID of the position information confirmation terminal, “35°40′33.2″N (north latitude) 139°44′41.9″E (east longitude)” is set as the position information, “aaaaa@example.com” is set as the address of the distributing destination, and “C:¥queue¥image.jpg” is set as the storage location of the data, with respect to a job ID “1-000-0001”.

FIG. 13 is a diagram illustrating the job registration table in one embodiment. The job registration table may be stored in the storage unit 206.

The job registration table illustrated in FIG. 13 may indicate the correspondence of a final execution date and time, a retry interval, and a number of executions. The retry interval may indicate a time interval at which the position information of the position information confirmation terminal is acquired, and this retry interval may be set in advance. The number of executions may indicate a number of times the position information of the position information confirmation terminal is acquired.

In the example illustrated in FIG. 13, the final execution date and time is “2011/10/1 10:00:00”, the retry interval is “1 minute”, and the number of executions is “3 times” for the job ID “1-000-0001”. In addition, the final execution date and time is “2011/10/1 10:00:15”, the retry interval is “1 minute”, and the number of executions is “2 times” for the job ID “1-000-0002”. Because a job ID “1-001-0001” is not executed, the final execution date and time is blank, the retry interval is “5 minutes”, and the number of executions is “0 times” for the job ID “1-001-0001”. Further, because the job ID “1-003-0005” is not executed, the final execution date and time is blank, the retry interval is “10 minutes”, and the number of executions is “0 times” for the job ID “1-003-0005”.

The CPU 208 may function as a distribution process part 2084. The distribution process part 2084 may acquire a job from the job registration process part 2082. The distribution process part 2084 may judge whether the acquired job satisfies a job executing condition. Conditions, such as whether the retry interval that is set in advance elapsed from the final execution date and time, and the like may be included the job executing condition. When the distribution process part 2084 judges that the data distribution request satisfies the job executing condition, the distribution process part 2084 may cause a position information judging part 2086 to judge whether the position of the position information confirmation terminal is within a range of the positional error. When the position information judging part 2086 judges that the position of the position information confirmation terminal is within the range of the positional error, the distribution process part 2084 may execute a control to distribute the data to the distributing destination. According to this control of the distribution process part 2084, the data may be transmitted from the second communication module 204 to the distributing destination.

The CPU 208 may function as the position information judging part 2086. The position information judging part 2086 may acquire the position information of the position information confirmation terminal according to a command from the distribution process part 2084, and judge from the position information whether the position is within the range of the positional error. The position information judging part 2086 may input a judgement result thereof, indicating whether position is within the range of the positional error, to the distribution process part 2084.

<Portable Terminal 300>

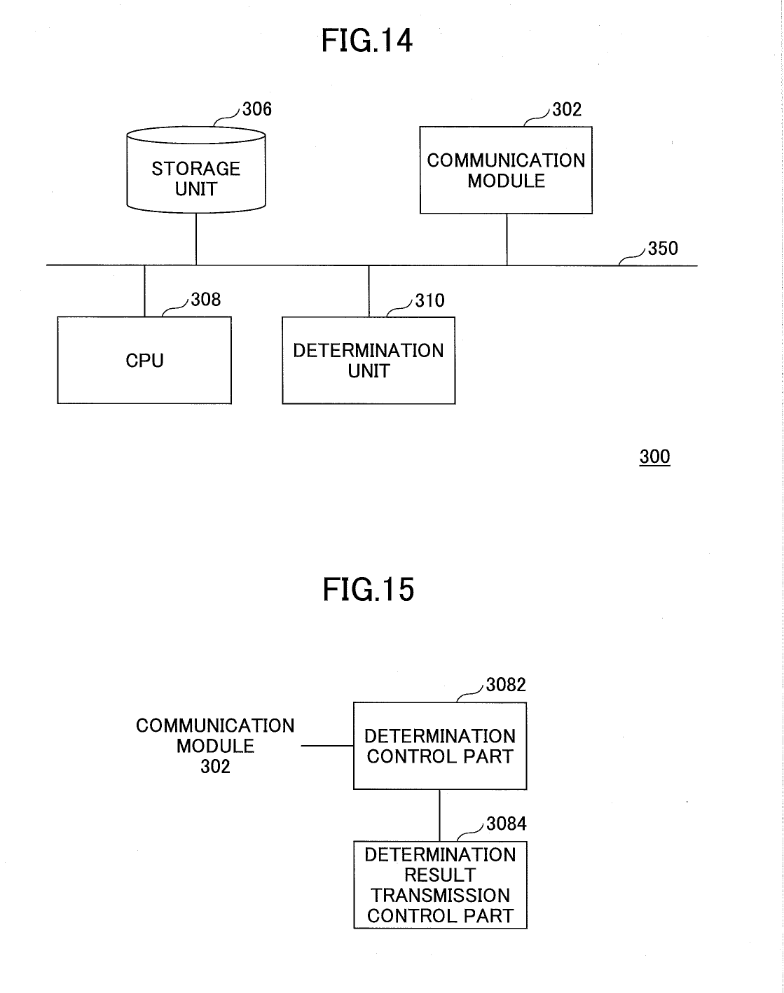

FIG. 14 is a diagram illustrating the portable terminal 300 in one embodiment.

As illustrated in FIG. 14, the portable terminal 300 may include a communication module 302, a storage unit 206, a CPU 308, and a determination unit (or measuring unit) 310. The communication module 302, the storage unit 306, the CPU 308, and the determination unit 310 may be connected via a bus 350.

The CPU 308 may control various parts of the portable terminal 300.

The communication module 302 may communicate with the distribution apparatus 200. The communication module 302 and the distribution apparatus 200 may be connected via a mobile communication system, a wireless LAN, and the like.

The storage unit 306 may store one or more application programs and an OS (Operating System). The application program is the software having functions enabling the user to execute operations on the portable terminal 300. The OS is the software providing hardware abstraction interfaces with respect to the application programs in the portable terminal 300.

The determination unit 310 may determine (or measure) the position of the portable terminal 300. More particularly, the determination unit 310 may determine the position of the portable terminal 300 using the GPS (Global Positioning System) or the GNSS (Global Navigation Satellite System), or using the wireless LAN.

<Functions of Portable Terminal 300>

A description will be given of the functions of the portable terminal 300 in one embodiment.

FIG. 15 is a functional block diagram illustrating the functions of the portable terminal 300 in one embodiment. The functions illustrated in FIG. 15 may mainly be executed by the CPU 308. In other words, the functions illustrated by the functional block diagram of FIG. 15 may be executed by the CPU 308 according to the application programs stored in the storage unit 306.

The CPU 308 may function as a determination (or measurement) control part 308. A determination (or measurement) request from the communication module 302 may be input to the determination control part 3082. The determination request may be obtained from the distribution apparatus 200. The determination control part 3082 may cause the determination unit 310 to execute the determination (or measurement) according to the determination request. The determination control part 3082 may input a determination result thereof to a determination result transmission control part 3084.

The CPU 308 may function as the determination result transmission control part 3084. The determination result transmission control part 3084 may execute a control to transmit the determination result from the determination control part 3082 to the distribution apparatus 200.

<Operation of Information Distribution System>

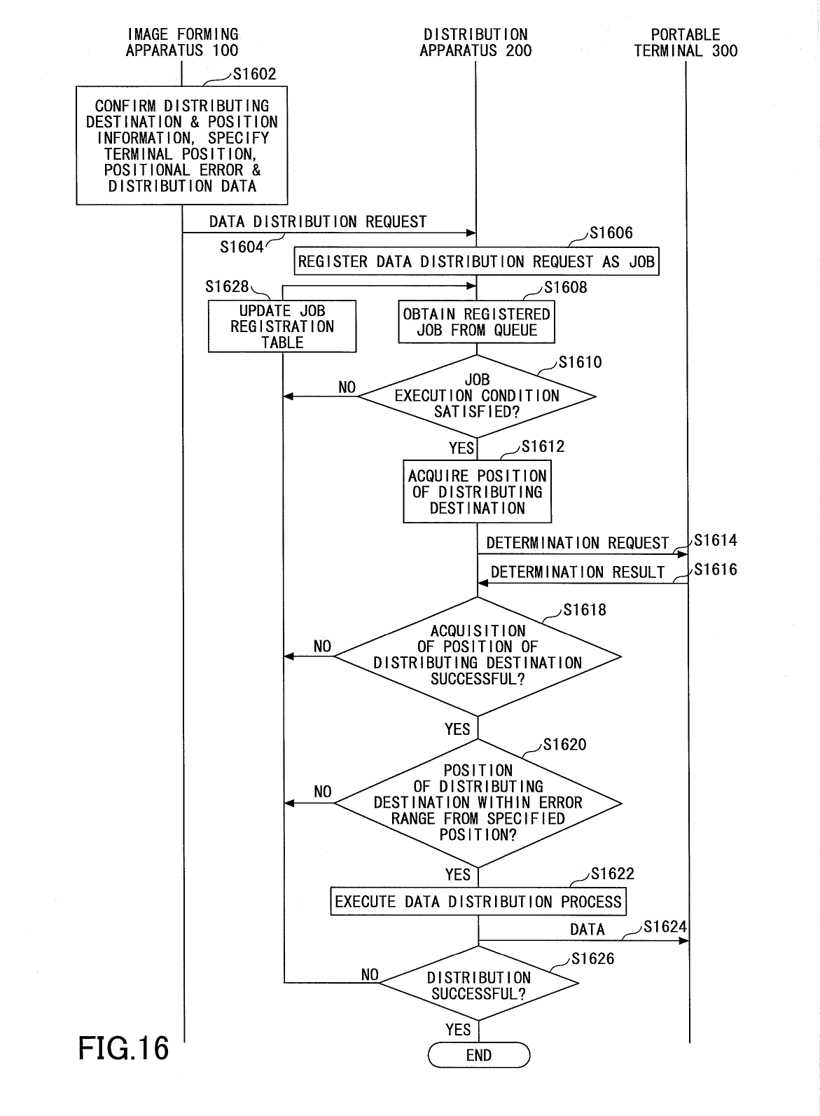

FIG. 16 is a diagram illustrating an operation of the information distribution system in one embodiment. In FIG. 16, a data distribution request is made from the image forming apparatus 100 to the portable terminal 300. In other words, the position information confirmation terminal and the portable terminal that receives the data from the image forming apparatus 100 are the same. The position information confirmation terminal and the portable terminal that receives the data from the image forming apparatus 100 are also the same when the data distribution request is made from the image forming apparatus 100 to the server 400.

In step S1602, the image forming apparatus 100 may specify the distributing destination, the position information confirmation terminal, the position, the positional error, and the distribution data. In other words, the data distribution specifying process part 1082 may specify the distributing destination, the position information confirmation terminal, the position, and the positional error, and the distribution data setting part 1084 sets the distribution data.

In step S1604, the image forming apparatus 100 may transmit the data distribution request to the distribution apparatus 200. In other words, the data distribution request transmitting part 1086 may transmit the data distribution request.

In step S1606, the distribution apparatus 200 may register the data distribution request as a job. In other words, the job registration process part 2082 may register the data distribution request from the image forming apparatus 100, as a job, in the job registration table.

In step S1608, the distribution apparatus 200 may extract the registered job from a queue. In other words, the distribution process part 2084 may extract the job from the job registration table.

In step S1610, the distribution process part 2084 may judge whether the job executing condition is satisfied.

When the job executing condition is satisfied, in step S1612, the position information judging part 2086 may acquire the position of the portable terminal 300 that is the distributing destination.

In step S1614, the position information judging part 2086 may execute a control to transmit the determination request to the portable terminal 300.

In step S1616, the position information judging part 2086 may acquire the determination result from the portable terminal 300.

In step S1618, the position information judging part 2086 may judge whether the acquisition of the position of the distributing destination is successful.

When the acquisition of the position of the distributing destination is successful, in step S1620, the position information judging part 2086 may judge whether the position of the portable terminal 300 that is the distributing destination is within the range of the positional error from the specified position.

When the position of the portable terminal 300 that is the distributing destination is within the range of the positional error from the specified position, in step S1622, the distribution process part 2084 may execute a data distribution process.

In step S1624, the distribution apparatus 200 may transmit the data to the portable terminal 300.

In step S1626, the distribution process part 2084 may judge whether the data distribution is successful.

The process ends when the data distribution is successful.

On the other hand, when the job executing condition is not satisfied in step S1610, or when the acquisition of the position of the distributing destination is unsuccessful (or fails) in step S1618, in step S1628, the distribution process part 2084 may update the job registration table. In addition, when the position of the portable terminal 300 that is the distributing destination is not within the range of the positional error from the specified position in step S1620, or when the data distribution is unsuccessful (or fails) in step S1626, in step S1628, the distribution process part 2084 may update the job registration table.

According to this embodiment, the distribution of information may be delayed until immediately before the information is required, and information leak due to movement may be prevented. In other words, when distributing the information in the information distribution system, the position of the distributing destination is acquired, and when the position of the distributing destination is within the range of the positional error from the specified position, the information may be distributed. For example, in a case in which the information is distributed to the portable terminal and the portable terminal is lost before the portable terminal reaches the specified position, the information leak may occur. However, in this embodiment, the information is not distributed and the distribution is delayed until immediately before the information is required, and for this reason, such information leak may be prevented.

<First Modification>

A modification of the information distribution system may change the retry interval depending on the distance between the specified position and the position of the position information confirmation terminal. When the distance between the specified position and the position of the position information confirmation terminal is long, it may be anticipated that a long time is required for the position of the position information confirmation terminal to fall within the range of the positional error from the specified position. In this case, if the position of the position information confirmation terminal are acquired at the constant retry interval, the power consumption may increase. Hence, this modification decreases the retry interval as the position of the position information confirmation terminal becomes closer to the specified position.

More particularly, the position information judging part 2086 may obtain the distance between the specified position and the position of the position information confirmation terminal when it is judged that the position of the position information confirmation terminal is not within the range of the positional error from the specified position. The position information judging part 2086 may set the retry interval depending on the obtained distance.

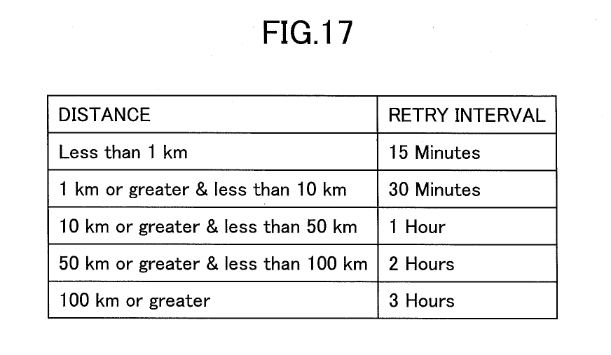

FIG. 17 is a diagram illustrating a retry interval setting table that is used when setting the retry interval in one embodiment. The retry interval setting table illustrated in FIG. 17 indicates the correspondence of the distance between the specified position and the position of the position information confirmation terminal and the retry interval. In the example illustrated in FIG. 17, the retry interval is 15 minutes when the distance is less than 1 km, the retry interval is 30 minutes when the distance is 1 km or greater and less than 10 km, and the retry interval is 1 hour when the distance is 10 km or greater and less than 50 km. In addition, the retry interval is 2 hours when the distance is 50 km or greater and less than 100 km, and the retry interval is 3 hours when the distance is 100 km or greater. The retry intervals illustrated in FIG. 17 are examples, and the retry intervals may be set arbitrarily.

<Operation of Information Distribution System>

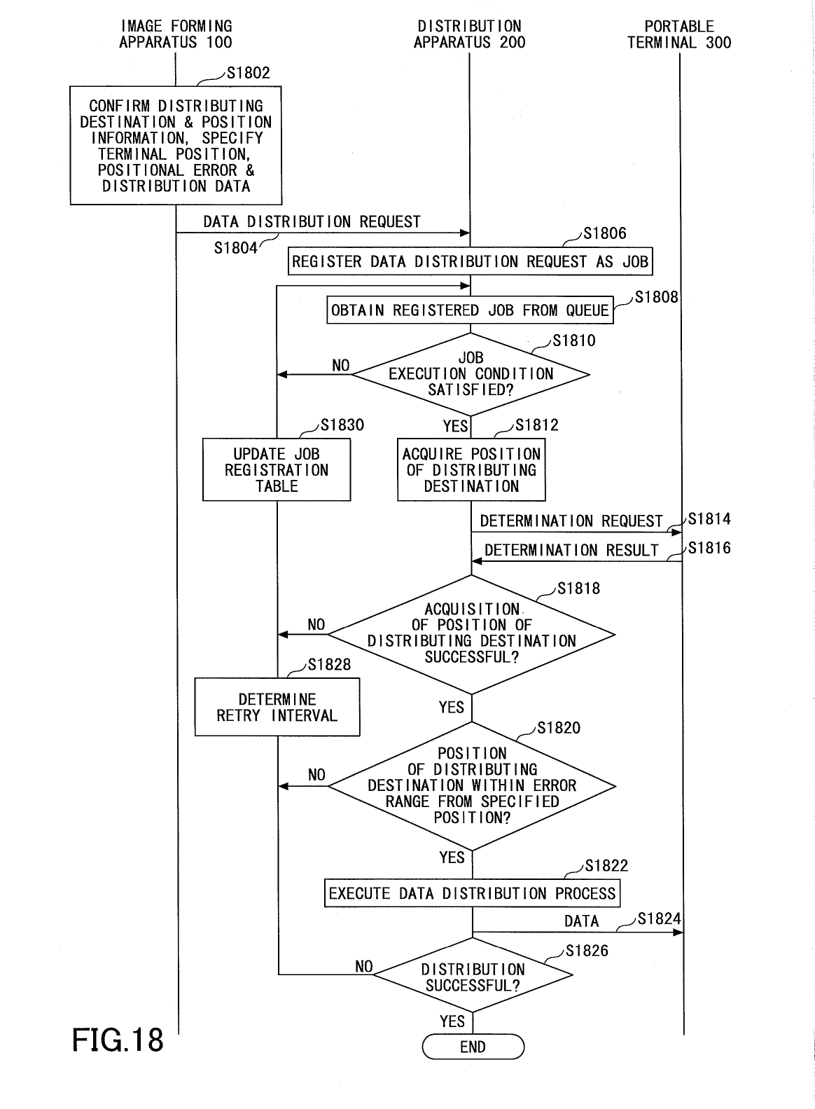

FIG. 18 is a diagram illustrating an operation of the information distribution system in one embodiment.

The operation of steps S1802 through S1826 are similar to the operation of steps S1602 through S1626 described in conjunction with FIG. 16.

When the position of the position information confirmation terminal is not within the range of the positional error from the specified position in step S1820, in step S1828, the position information judging part 2086 may determine the retry interval.

When the acquisition of the position of the position information confirmation terminal is unsuccessful (or fails) in step S1818, and after the retry interval is determined in step S1828, in step S1830, the distribution process part 2084 may update the job registration table. When updating the job registration table, the distribution process part 2084 may also update the retry interval.

According to this modification, the retry interval may be increased when the distance between the specified position and the position of the position information confirmation terminal is long, and the retry interval may be decreased when the distance between the specified position and the position of the position information confirmation terminal is short. For this reason, in addition to obtaining the effects of the embodiment described above, this modification may reduce the number of times the position of the position information confirmation terminal is acquired, and reduce the power consumption of the distribution apparatus 200. In addition, the power consumption of the portable terminal 300 may be reduced, because the number of times the determination process is performed in the portable terminal 300 may be reduced.

<Second Modification>

Another modification of the information distribution system may change the retry interval depending on the distance between the specified position and the position of the position information confirmation terminal, and on a velocity of the position information confirmation terminal. Even when the distance between the specified position and the position of the position information confirmation terminal is long, it may be anticipated that a time required for the position of the position information confirmation terminal to fall within the range of the positional error from the specified position may be short in a case in which the position information confirmation terminal moves at a high velocity. In addition, even when the distance between the specified position and the position of the position information confirmation terminal is short, it may be anticipated that a time required for the position of the position information confirmation terminal to fall within the range of the positional error from the specified position may be long in a case in which the position information confirmation terminal moves at a low velocity. In these cases, if the position of the position information confirmation terminal are acquired at the constant retry interval, the power consumption may increase. Hence, this modification changes the retry interval depending on the distance between the specified position and the position of the position information confirmation terminal, and on the moving velocity of the position information confirmation terminal.

More particularly, the position information judging part 2086 may obtain the distance between the specified position and the position of the position information confirmation terminal when it is judged that the position of the position information confirmation terminal is not within the range of the positional error from the specified position. Further, the position information judging part 2086 may acquire the velocity of the position information confirmation terminal. The position information judging part 2086 may set the retry interval depending on the obtained distance and the acquired velocity.

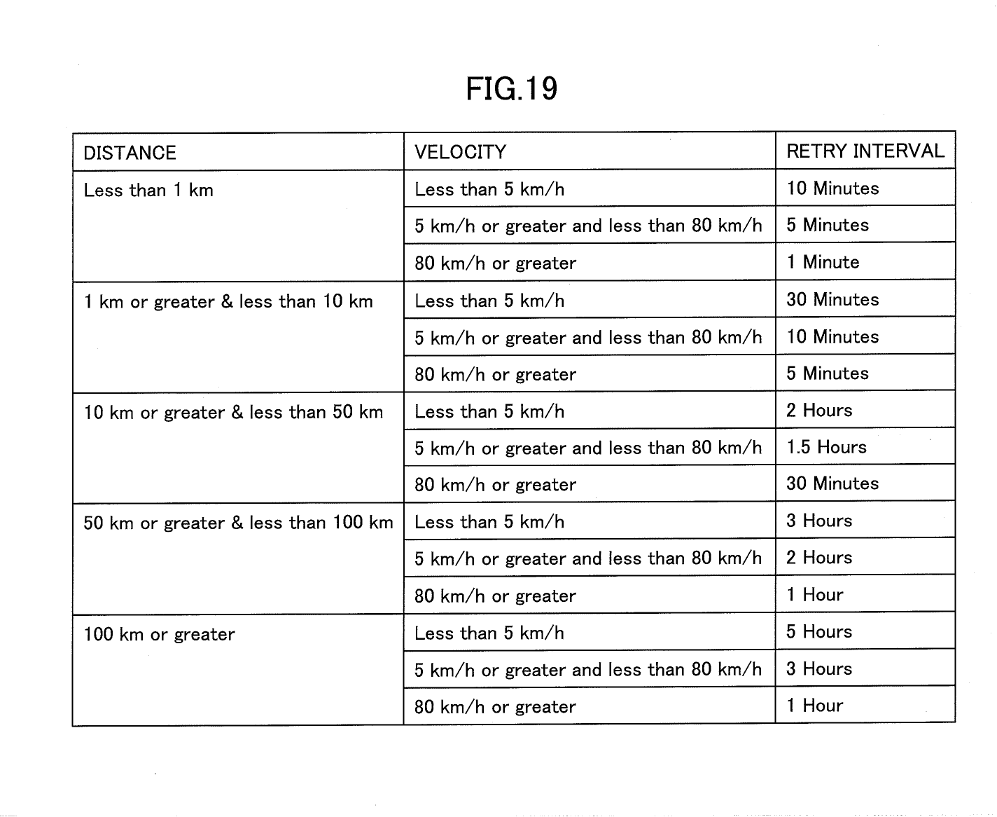

FIG. 19 is a diagram illustrating the retry interval setting table that is used when setting the retry interval in one embodiment. The retry interval setting table illustrated in FIG. 19 indicates the correspondence of a combination of the distance between the specified position and the position of the position information confirmation terminal and the velocity of the distributing destination, and the retry interval. In the example illustrated in FIG. 19, when the distance is less than 1 km, the retry interval is 10 minutes when the velocity is less than 5 kilometers/hour (km/h), the retry interval is 5 minutes when the velocity is 5 km/h or greater and less than 80 km/h, and the retry interval is 1 minute when the velocity is 80 km/h or greater.

In addition, when the distance is 1 km or greater and less than 10 km, the retry interval is 30 minutes when the velocity is less than 5 km/h, the retry interval is 10 minutes when the velocity is 5 km/h or greater and less than 80 km/h, and the retry interval is 5 minutes when the velocity is 80 km/h or greater.

When the distance is 10 km or greater and less than 50 km, the retry interval is 2 hours when the velocity is less than 5 km/h, the retry interval is 1.5 hours when the velocity is 5 km/h or greater and less than 80 km/h, and the retry interval is 30 minutes when the velocity is 80 km/h or greater.

Moreover, when the distance is 50 km or greater and less than 100 km, the retry interval is 3 hours when the velocity is less than 5 km/h, the retry interval is 2 hours when the velocity is 5 km/h or greater and less than 80 km/h, and the retry interval is 1 hour when the velocity is 80 km/h or greater.

When the distance is 100 km or greater, the retry interval is 5 hours when the velocity is less than 5 km/h, the retry interval is 3 hours when the velocity is 5 km/h or greater and less than 80 km/h, and the retry interval is 1 hour when the velocity is 80 km/h or greater. The retry intervals illustrated in FIG. 19 are examples, and the retry intervals may be set arbitrarily.

<Operation of Information Distribution System>

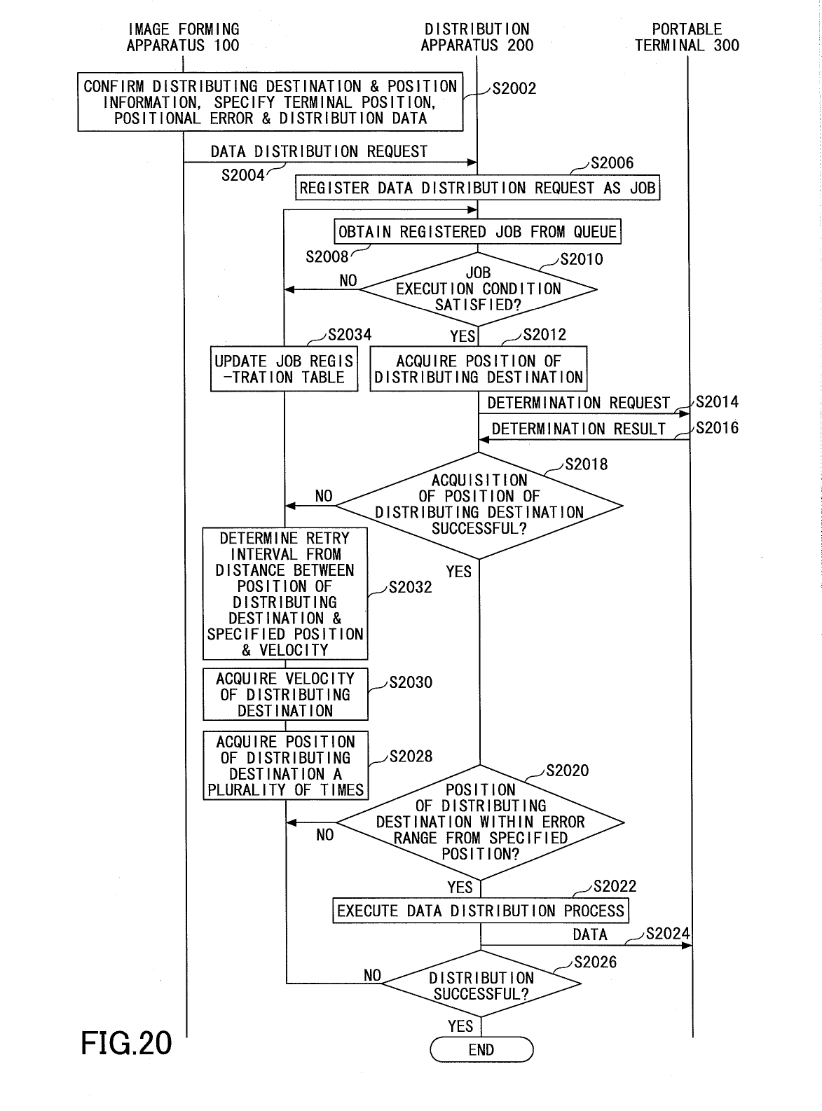

FIG. 20 is a diagram illustrating an operation of the information distribution system in one embodiment.

The operation of steps S2002 through S2026 are similar to the operation of steps S1602 through S1626 described in conjunction with FIG. 16.

When the position of the position information confirmation terminal is not within the range of the positional error from the specified position in step S2020, in step S2028, the position information judging part 2086 may acquire the position of the position information confirmation terminal a plurality of times.

In step S2030, the position information judging part 2086 may acquire the velocity of the position information confirmation terminal.

In step S2032, the position information judging part 2086 may refer to the retry interval setting table, based on an average value of the position of the position information confirmation terminal acquired in step S2028 and the velocity of the position information confirmation terminal acquired in step S2030, in order to determine the retry interval.

When the acquisition of the position of the position information confirmation terminal in step S2018 is unsuccessful (or fails), and after the retry interval is determined in step S2032, in step S2034 the distribution process part 2084 may update the job registration table. When updating the job registration table, the distribution process part 2084 may also update the retry interval.

According to this modification, the retry interval may be set based on the distance between the specified position and the position of the position information confirmation terminal and the velocity of the position information confirmation terminal. For this reason, in addition to obtaining the effects of the embodiment and the first modification described above, this modification may further reduce the number of times the position of the position information confirmation terminal is acquired, and further reduce the power consumption of the distribution apparatus 200, when compared to the first modification. In addition, the power consumption of the portable terminal 300 may further be reduced, because the number of times the determination process is performed in the portable terminal 300 may further be reduced.

<Third Modification>

Still another modification of the information distribution system may judge by the portable terminal 300 whether the portable terminal 300 reached the specified position.

<Function of Distribution Apparatus 200>

The functions of the distribution apparatus 200 may be approximately the same as those of the embodiment illustrated in FIG. 11. When the position is not acquired from the portable terminal 300 or when it is judged that the position from the portable terminal 300 is not within the range of the positional error from the specified position, the position information judging part 2086 may request position judgement to the portable terminal 300. The position judgement request may include the specified position, the positional error, and the like. When a notification is received from the portable terminal 300 that the portable terminal 300 reached the specified position, the distribution process part 2084 may distribute the data to the portable terminal 300.

<Functions of Portable Terminal 300>

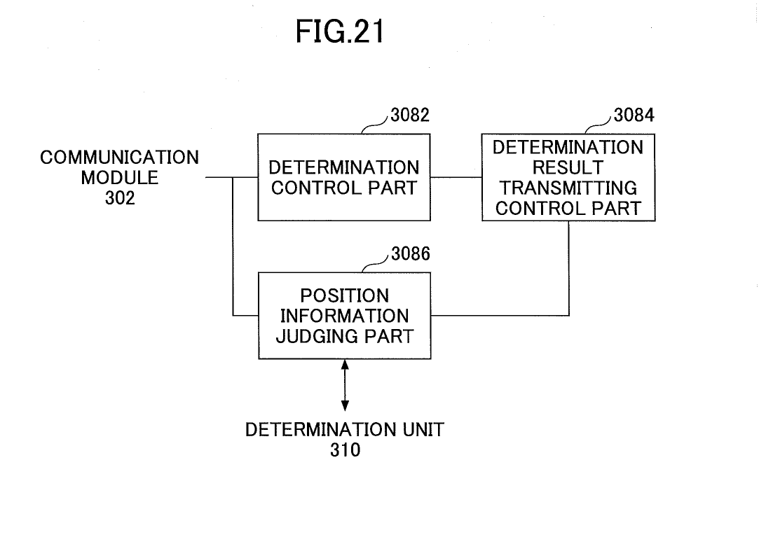

FIG. 21 is a functional block diagram illustrating the portable terminal 300 in one embodiment.

The functions of the portable terminal 300 in one embodiment may include position information judging part 3086 in addition to the functional blocks described above in conjunction with FIG. 15.

The position judgement request from the communication module 302 may be input to the position information judging part 3086. This position judgement result may be transmitted from the distribution apparatus 200. The position judgement request may include the position information and the positional error. The position information judging part 3086 may make a determination request to the determination unit 310. The position information judging part 3086 may execute a control to notify the distribution apparatus 200 that the portable terminal 300 reached the specified position, when the determination result from the determination unit 310 indicates the position within the range of the positional error from the specified position.

<Operation of Information Distribution System>

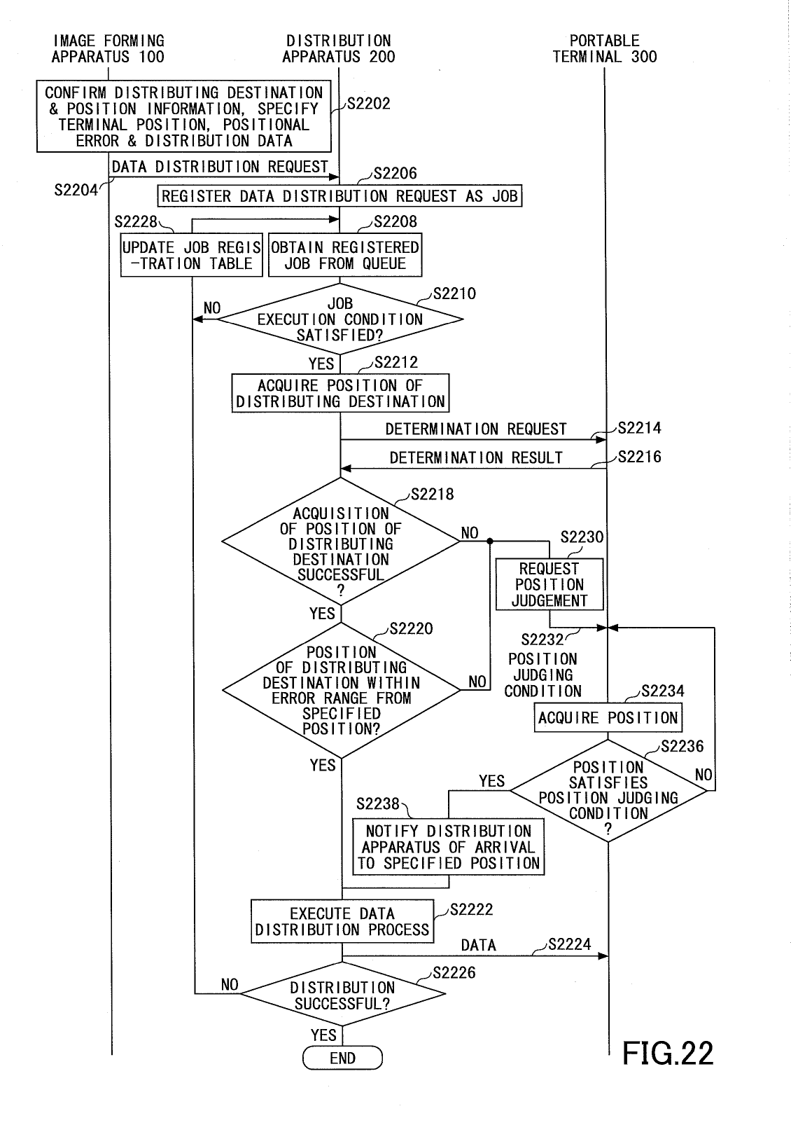

FIG. 22 is a diagram illustrating an operation of the information distribution system in one embodiment.

The operation of steps S2202 through S2228 are similar to the operation of steps S1602 through S1628 described in conjunction with FIG. 16.

When the acquisition of the position of the distributing destination is unsuccessful (or fails) in step S2218, and the position of the distributing destination is not within the range of the positional error from the specified position in step S2220, in step S2230, the position information judging part 3086 may request position judgement to the portable terminal 300.

In step S2232, the position judgement request from the distribution apparatus 200 may be transmitted to the portable terminal 300.

In step S2234, the portable terminal 300 may acquire the position. In other words, the determination unit 310 may execute the determination.

In step S2236, the position information judging part 3086 may judge whether the position determined in step S2234 satisfies the position judging condition. In other words, the position information judging part 3086 may judge whether the position determined in step S2234 is within the range of the positional error from the specified position.

When the determined position is within the range of the positional error from the specified position in step S2236, in step S2238, the determination result transmitting control part 3084 may notify the distribution apparatus 200 that the portable terminal 300 reached the specified position. Thereafter, the process advances to step S2222.

On the other hand, when the determined position is not within the range of the positional error from the specified position in step S2236, the process returns to step S2234.

According to this modification, the position information judgement is executed in the portable terminal 300, and thus, the processing load on the distribution 200 may be reduced.

### Examples of Applications of Information Distribution System

### First Example

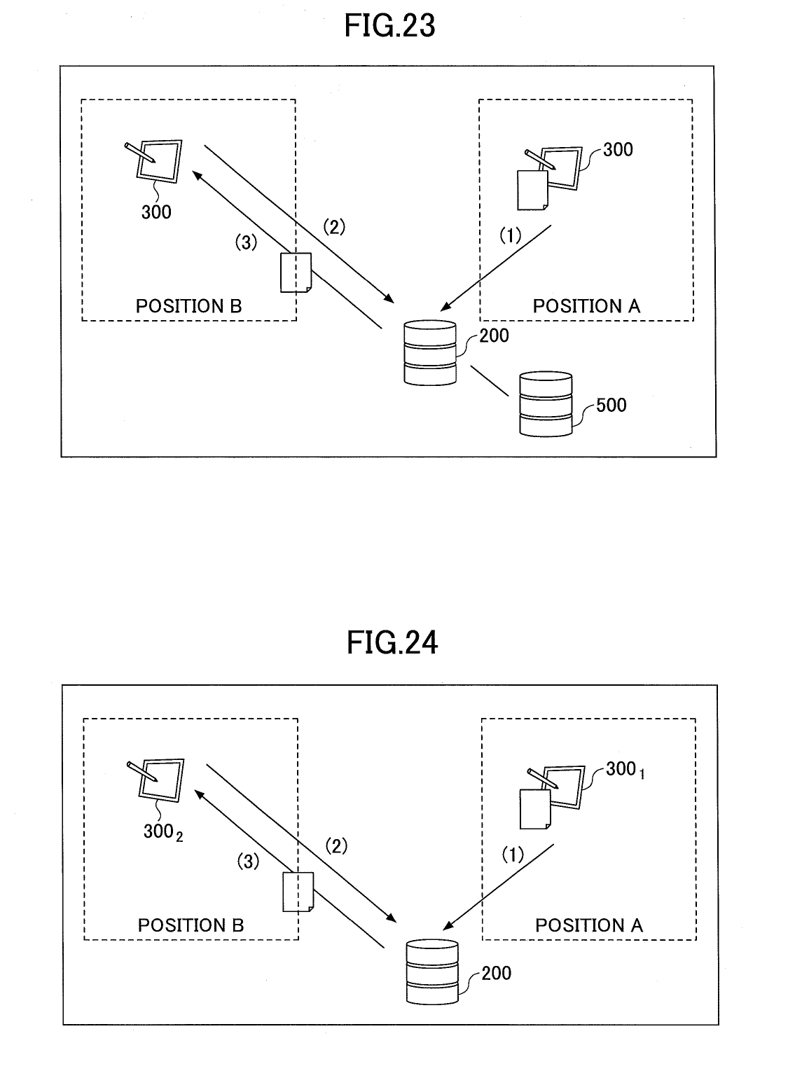

FIG. 23 is a diagram illustrating a first example of an application of the information distribution system.

In the example illustrated in FIG. 23, a portable terminal 300 is used in place of the image forming apparatus 100 illustrated in FIG. 1. In the example illustrated in FIG. 23, the data distribution request from the portable terminal 300 may be received by the same portable terminal 300.

In step (1), the portable terminal 300 at a position A may request the distribution apparatus 200 to distribute the data (or file) stored in the storage unit 500 when the portable terminal 300 reaches a position B. In step (2), the portable terminal 300 may transmit its position to the distribution apparatus 200. In step (3), when the position received from the portable terminal 300 corresponds to the position B, the distribution apparatus 200 may transmit the data (or file) stored in the storage unit 500 to the portable terminal 300 at the position B.

According to this application, the required data may be received by the portable terminal 300 when the portable terminal 300 reaches the position where the data is required. For this reason, in a case in which the portable terminal 300 is lost before the position where the data is required is reached, information leak may be prevented because the data is not distributed to the portable terminal 300.

### Second Example

FIG. 24 is a diagram illustrating a second example of the application of the information distribution system.

In the example illustrated in FIG. 24, a portable terminal 300 is used in place of the image forming apparatus 100 illustrated in FIG. 1. In the example illustrated in FIG. 24, the data requested by the data distribution request from a portable terminal 300₁ may be received by a different portable terminal 300₂.

In step (1), the portable terminal 300₁ at the position A may request distribution of the data (or file) to the distribution apparatus 200 when the portable terminal 300₂ reaches the position B. In step (2), the portable terminal 300₂ at the position B may transmit its position to the distribution apparatus 200. In step (3), the distribution apparatus 200 may transmit the requested data (or file) to the portable terminal 300₂ when the position of the portable terminal 300₂ received in step (2) corresponds to the position B.

According to this application, the portable terminal 300₂ may be caused to receive the required data when the portable terminal 300₂ reaches the position where the data is required. For this reason, in a case in which the portable terminal 300₂ is lost before the position where the data is required is reached, information leak may be prevented because the data is not distributed to the portable terminal 300₂.

### Third Example

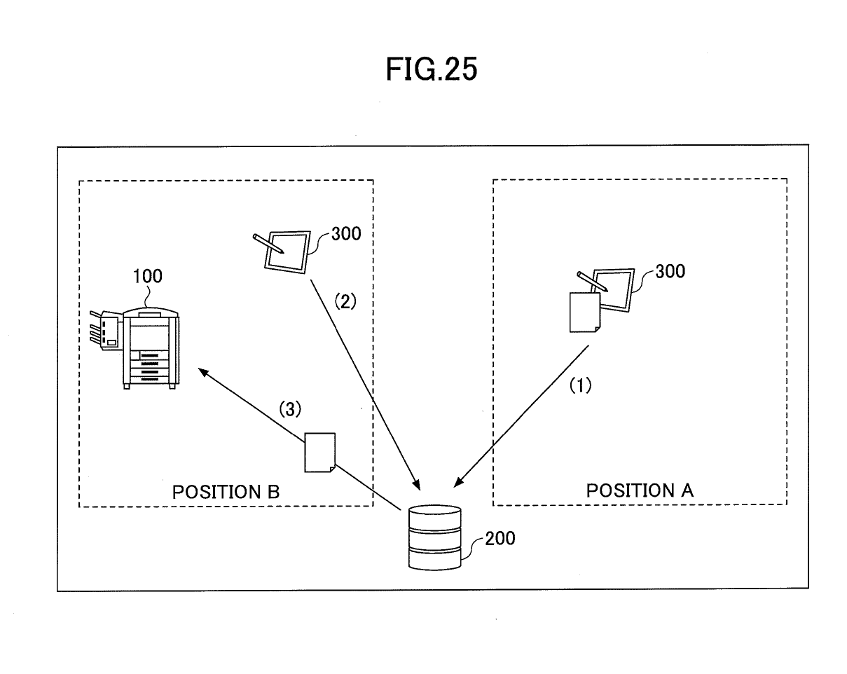

FIG. 25 is a diagram illustrating a third example of the application of the information distribution system.

In the example illustrated in FIG. 25, a portable terminal 300 is used in place of the image forming apparatus 100 illustrated in FIG. 1. In the example illustrated in FIG. 25, the data requested by the data distribution request from the portable terminal 300 may be received by the image forming apparatus 100.

In step (1), the portable terminal 300 at the position A may request the distribution apparatus 200 to transmit the data to the image forming apparatus 100 when the portable terminal 300 reaches the position B. In step (2), the portable terminal 300 may transmit its position to the distribution apparatus 200. In step (3), the distribution apparatus 200 may transmit the data (or file) to the image forming apparatus 100 when the position of the portable terminal 300 corresponds to the position B.

According to this application, the required data may be distributed to the image forming apparatus 100 when the portable terminal 300 reaches the position where the data is required. For this reason, in a case in which the portable terminal 300 is lost before the position where the data is required is reached, information leak may be prevented because the data is not distributed to the portable terminal 300.

In this case, the user of the portable terminal 300 needs to know the image forming apparatus 100 to which the required data is output. For example, wireless communication may be made between the portable terminal 300 and the image forming apparatus 100 by near field communication, in order to enable comparison of identifiers thereof. The near field communication may include ZIGBEE (registered trademark), BLUETOOTH (registered trademark), and the like. More particularly, the portable terminal 300 may receive the identifier, such as an IP address or the like, of the image forming apparatus 100, and judge whether the identifier received from the image forming apparatus 100 matches the address of the distributing destination. The user of the portable terminal 300 may know that the required data is output from the image forming apparatus 100 having the identifier matching the address of the distributing destination. On the other hand, the image forming apparatus 100 may receive the identifier, such as the IP address or the like, of the portable terminal 300. The image forming apparatus 100 may output the required data when the identifier received from the portable terminal 300 matches the address of the distributing destination.

### Fourth Example

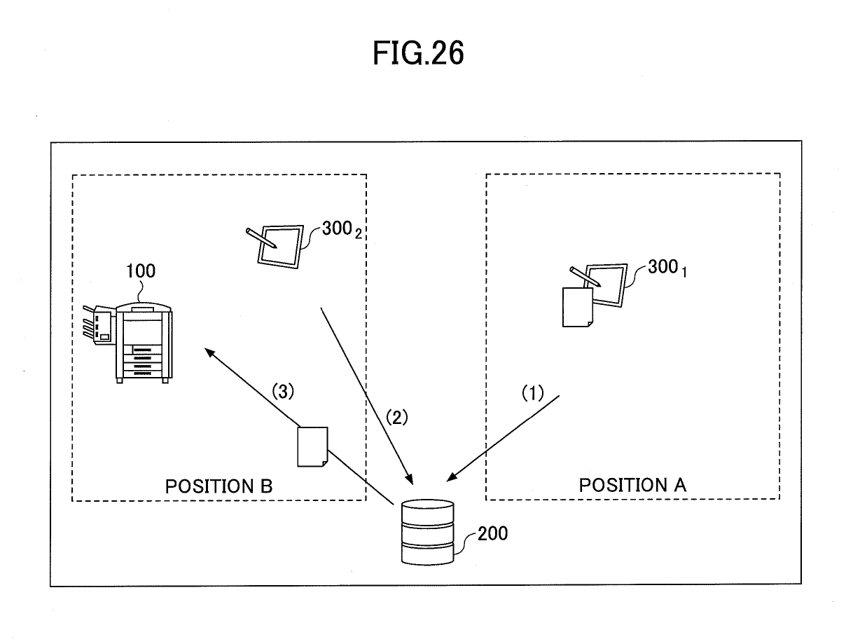

FIG. 26 is a diagram illustrating a fourth example of the application of the information distribution system.

In the example illustrated in FIG. 26, a portable terminal 300 is used in place of the image forming apparatus illustrated in FIG. 1. In the example illustrated in FIG. 26, the data requested by the data distribution request from the portable terminal 300₁ may be received by the image forming apparatus 100. In step (1), the portable terminal 300₁ at the position A may request the distribution apparatus 200 to transmit the data (or file) to the image forming apparatus 100 when a portable terminal 300₂ reaches the position B. In step (2), the portable terminal 300₂ may transmit its position to the distribution apparatus 200. In step (3), the distribution apparatus 200 may transmit the data (or file) to the image forming apparatus 100 when the position of the portable terminal 300₂ corresponds to the position B.

According to this application, the required data may be distributed to the image forming apparatus 100 when the portable terminal 300₂ reaches the position where the data is required. For this reason, in a case in which the portable terminal 300₂ is lost before the position where the data is required is reached, information leak may be prevented because the data is not distributed to the portable terminal 300₂.

In this case, the user of the portable terminal 300₂ needs to know the image forming apparatus 100 to which the required data is output. For example, wireless communication may be made between the portable terminal 300₂ and the image forming apparatus 100 by near field communication, in order to enable comparison of identifiers thereof. The near field communication may include ZIGBEE (registered trademark), BLUETOOTH (registered trademark), and the like. More particularly, the portable terminal 300₂ may receive the identifier, such as an IP address or the like, of the image forming apparatus 100, and judge whether the identifier received from the image forming apparatus 100 matches the address of the distributing destination. The address of the distributing destination may be notified when the determination request is made from the distribution apparatus 200. The user of the portable terminal 300₂ may know that the required data is output from the image forming apparatus 100 having the identifier matching the address of the distributing destination. On the other hand, the image forming apparatus 100 may receive the identifier, such as the IP address or the like, of the portable terminal 300₂. The image forming apparatus 100 may output the required data when the identifier received from the portable terminal 300₂ matches the address of the distributing destination.

### Fifth Example

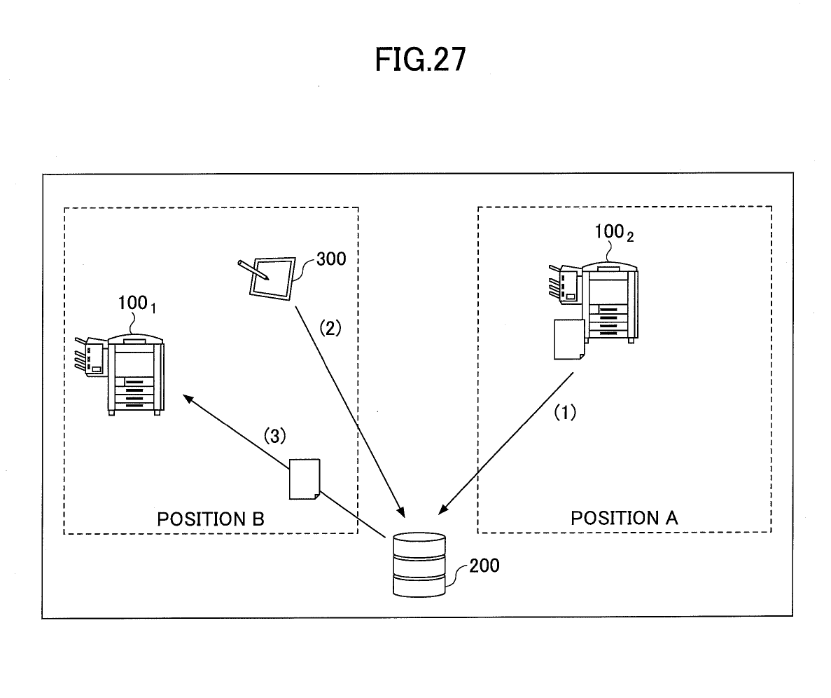

FIG. 27 is a diagram illustrating a fifth example of the application of the information distribution system.

In the example illustrated in FIG. 27, the data requested by an image forming apparatus 100₂ is received by an image forming apparatus 100₁.

In step (1), the image forming apparatus 100₂ at the position A may request the distribution apparatus 200 to distribute the data (or file) to the image forming apparatus 100₁ when the portable terminal 300 reaches the position B. In step (2), the portable terminal 300 may transmit its position to the distribution apparatus 200. In step (3), the distribution apparatus 200 may transmit the data (or file) to the image forming apparatus 100₁ when the position of the portable terminal 300 corresponds to the position B.

According to this application, the image forming apparatus 100₂ may be caused to output the required data when the portable terminal 300 reaches the position where the data is required. For this reason, in a case in which the portable terminal 300 is lost before the position where the data is required is reached, information leak may be prevented because the data is not distributed to the portable terminal 300.

In this case, the user of the portable terminal 300 needs to know the image forming apparatus 100₁ to which the required data is output. For example, wireless communication may be made between the portable terminal 300 and the image forming apparatus 100₁ by near field communication, in order to enable comparison of identifiers thereof. The near field communication may include ZIGBEE (registered trademark), BLUETOOTH (registered trademark), and the like. More particularly, the portable terminal 300 may receive the identifier, such as an IP address or the like, of the image forming apparatus 100₁, and judge whether the identifier received from the image forming apparatus 100₁ matches the address of the distributing destination. The address of the distributing destination may be notified when the determination request is made from the distribution apparatus 200. The user of the portable terminal 300 may know that the required data is output from the image forming apparatus 100₁ having the identifier matching the address of the distributing destination. On the other hand, the image forming apparatus 100₁ may receive the identifier, such as the IP address or the like, of the portable terminal 300. The image forming apparatus 100₁ may output the required data when the identifier received from the portable terminal 300 matches the address of the distributing destination.

### Sixth Example

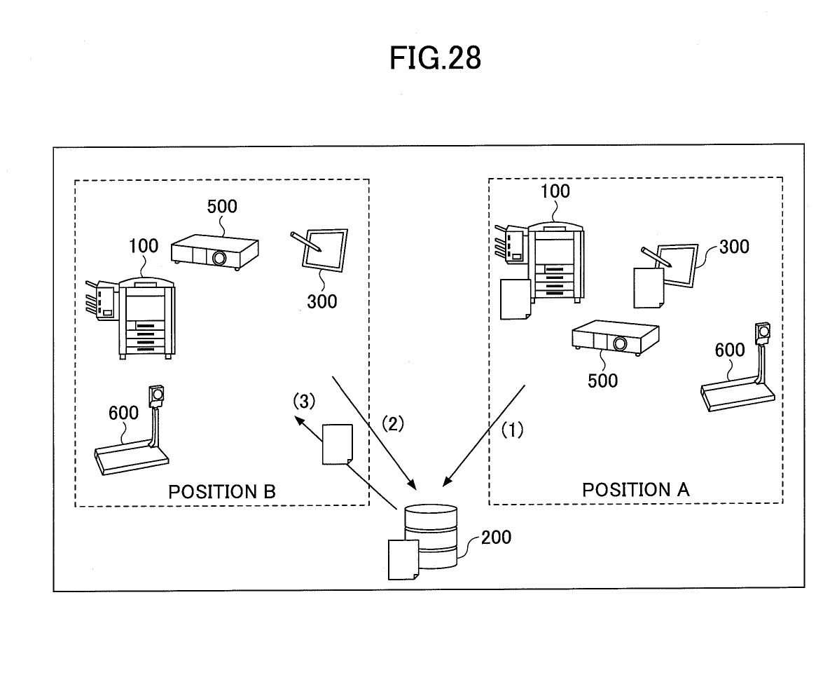

FIG. 28 is a diagram illustrating a sixth example of the application of the information distribution system.

In the example illustrated in FIG. 28, apparatuses capable of requesting the data by the data distribution request may include an image forming apparatus 100, a portable terminal 300, a projector 500, and a communication apparatus (or unified communication apparatus) 600. In addition, apparatuses capable of receiving the data distribution request may include an image forming apparatus 100, a portable terminal 300, a projector 500, and a communication apparatus 600.

The apparatus that requests distribution of the data and the apparatus that receives the requested data may be the same apparatus or may be different apparatuses.

In step (1), the apparatus at the position may request the distribution apparatus 200 to distribute data. The apparatus to receive the data, the apparatus that acts as a trigger for the data distribution, the data distributing condition, the position, the distribution data, and the like may be specified when making the data distribution request.

In step (2), the apparatus that acts as the trigger for the data distribution may transmit its position to the distribution apparatus 200.

In step (3), the distribution apparatus 200 may transmit the data (or file) to the apparatus that is to receive the data (or file), when the position received from the apparatus that acts as the trigger for the data (or file) distribution corresponds to the position B.

According to this application, when the apparatus that acts as the trigger to distribute the data reaches the specified position, the data may be transmitted to this apparatus at the distributing destination. For this reason, when the apparatus that acts as the rigger to distribute the data is lost, information leak may be prevented because the data is not transmitted. The apparatus that acts as the trigger for the data distribution may include a mobile communication apparatus and the like.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP (Wireless Application Protocol) or 3G-compliant phone) and so on. Since the present invention can be implemented as software, each and every aspect of the present invention thus encompasses computer software implementable on a programmable device.

The computer software can be provided to the programmable device using any storage medium or carrier medium for storing processor readable code such as a floppy disk, a hard disk, a CD-ROM (Compact Disk-Read Only Memory), a magnetic tape device or a solid state memory device.

The hardware platform includes any desired hardware resources including, for example, a CPU, a RAM (Random Access Memory), and a HDD (Hard Disk Drive). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

Although the modifications and the examples are numbered with, for example, “first”, “second”, . . . , the ordinal numbers do not imply priorities of the modifications or the examples. Many other variations and modifications will be apparent to those skilled in the art.

Further, the present invention is not limited to these embodiments, but various variations and modifications, substitutions, replacements, and the like may be made without departing from the scope of the present invention. Although the apparatuses in the embodiments and examples are described with reference to the functional block diagrams, the apparatuses may be realized by hardware, software, or a combination of hardware and software.

What is claimed is:

1. A distribution apparatus comprising:
a judging unit configured to judge whether to distribute data, based on first position information received from an apparatus and position condition information that is preset; and
a data distributing unit configured to distribute the data to a distributing destination when the judging unit judges to distribute the data.

2. The distribution apparatus as claimed in claim 1, wherein the data distributing unit distributes the data to the apparatus from which the first position information is received, as the distributing destination, when the judging unit judges to distribute the data.

3. The distribution apparatus as claimed in claim 1, wherein the data distributing unit distributes the data to another apparatus that is specified as the distributing destination when the judging unit judges to distribute the data.

4. The distribution apparatus as claimed in claim 1, wherein
the position condition information includes apparatus identification information and second position information, and
the judging unit judges whether to distribute the data based on apparatus identification information of the apparatus from which the first position information is received, the first position information received from the apparatus, and the position condition information.

5. The distribution apparatus as claimed in claim 1, wherein
the position condition information includes apparatus identification information and second position information, and is related to the distributing destination and the data to be distributed,
the judging unit judges whether to distribute the data based on apparatus identification information of the apparatus from which the first position information is received, the first position information received from the apparatus, and the position condition information, and
the data distributing unit distributes the related data to the related distributing destination when the judging unit judges to distribute the data.

6. The distribution apparatus as claimed in claim 5, further comprising:
a receiving unit configured to receive the data, the distributing destination of the data, and the position condition information via a network; and
a storage process unit configured to store the data, the distributing destination of the data, and the position condition information received by the receiving unit in a storage unit,
wherein the judging unit judges whether to distribute the data based on the apparatus identification information of the apparatus from which the first position information is received, the first position information received from the apparatus, and the position condition information stored in the storage unit.

7. The distribution apparatus as claimed in claim 6, wherein
the receiving unit receives the data, the distributing destination of the data, and the position condition information from an image forming apparatus via the network, and
the data distributing unit distributes the data to a portable terminal, as the distributing destination.

8. The distribution apparatus as claimed in claim 6, wherein
the receiving unit receives the data, the distributing destination of the data, and the position condition information from a first portable terminal via the network, and
the data distributing unit distributes the data to a second portable terminal that is different from the first portable terminal, as the distributing destination.

9. The distribution apparatus as claimed in claim 6, wherein
the receiving unit receives the data, the distributing destination of the data, and the position condition information from a portable terminal via the network, and
the data distributing unit distributes the data to an image forming apparatus, as the distributing destination.

10. The distribution apparatus as claimed in claim 6, wherein
the receiving unit receives from a first apparatus via the network, the data, apparatus identification information of a second apparatus as the distributing destination of the data, and apparatus identification information of a third apparatus as the position condition information, and the second position information,
the judging unit judges whether to distribute the data based on the apparatus identification information of the apparatus from which the first position information is received, the first position information received from the apparatus, and the position condition information, and
the data distributing unit distributes the related data to the second apparatus as the related distributing destination, when the judging unit judges to distribute the data.

11. A distribution method comprising:
judging, in a judging unit, whether to distribute data, based on first position information received from an apparatus and position condition information that is preset; and
distributing, from a data distributing unit, the data to a distributing destination when the judging judges to distribute the data.

12. The distribution method as claimed in claim 11, wherein the distributing distributes the data to the apparatus from which the first position information is received, as the distributing destination, when the judging judges to distribute the data.

13. The distribution method as claimed in claim 11, wherein the distributing distributes the data to another apparatus that is specified as the distributing destination when the judging judges to distribute the data.

14. The distribution method as claimed in claim 11, wherein
the position condition information includes apparatus identification information and second position information, and
the judging judges whether to distribute the data based on apparatus identification information of the apparatus from which the first position information is received, the first position information received from the apparatus, and the position condition information.

15. The distribution method as claimed in claim 11, wherein
the position condition information includes apparatus identification information and second position information, and is related to the distributing destination and the data to be distributed,
the judging judges whether to distribute the data based on apparatus identification information of the apparatus from which the first position information is received, the first position information received from the apparatus, and the position condition information, and
the data distributing distributes the related data to the related distributing destination when the judging judges to distribute the data.

16. A distribution system comprising:
a plurality of apparatuses configured to communicate with each other,
wherein a first apparatus amongst the plurality of apparatuses performs a process including
judging whether to distribute data, based on first position information received from a second apparatus amongst the plurality of apparatuses and position condition information that is preset; and
distributing the data to a distributing destination when the judging judges to distribute the data.

17. The distribution system as claimed in claim 16, wherein the distributing distributes the data to the second apparatus from which the first position information is received, as the distributing destination, when the judging judges to distribute the data.

18. The distribution system as claimed in claim 16, wherein the distributing distributes the data to a third apparatus amongst the plurality of apparatuses, that is specified as the distributing destination, when the judging judges to distribute the data.

19. The distribution system as claimed in claim 16, wherein
the position condition information includes apparatus identification information and second position information, and
the judging judges whether to distribute the data based on apparatus identification information of the second apparatus from which the first position information is received, the first position information received from the second apparatus, and the position condition information.

20. The distribution system as claimed in claim 16, wherein
the position condition information includes apparatus identification information and second position information, and is related to the distributing destination and the data to be distributed,
the judging judges whether to distribute the data based on apparatus identification information of the second apparatus from which the first position information is received, the first position information received from the second apparatus, and the position condition information, and
the distributing distributes the related data to the related distributing destination when the judging judges to distribute the data.
